(19) United States
(12) Patent Application Publication
(10) Pub. No.: US 2009/0103287 A1
(43) Pub. Date: Apr. 23, 2009

(54) ORNAMENT HAVING AN INTERNAL ELECTRIC LIGHTING ADAPTABLE TO VARIOUS LIGHTING EFFECTS

(75) Inventor: Mark Medley, Azusa, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ENCHANTED LIGHTING COMPANY, LLC, San Dimas, CA (US)

(21) Appl. No.: 12/036,132

(22) Filed: Feb. 22, 2008

Related U.S. Application Data
(60) Provisional application No. 60/982,085, filed on Oct. 23, 2007.

(51) Int. Cl. F21S 6/00; H05B 41/36

(52) U.S. Cl. 362/122; 315/291

(57) ABSTRACT

According to one embodiment, an improved ornament is provided which comprises a light source which produces the lighting effect emulating the lighting from a candle flame.

This application claims the benefit of priority on U.S. Provisional Application No. 60/982,085 filed Oct. 23, 2007, where the contents herein are incorporated by reference.

### FIELD

Embodiments of the invention relates to the field of ornaments. More particularly, embodiment of the invention is directed to an ornament having internal lighting which emulates candle light.

### GENERAL BACKGROUND

For centuries, ornaments containing wax candles have been used as decoration. For example, before there was electricity, Christmas trees were lit with candles. However, the use of open flame candles as ornamentation has greatly decreased given the high cost of using candles and the safety hazards posed by leaving open flames unattended. These candles also create a risk of harm to small children who are unaware of the dangers of fire.

It is known in the prior art to use electric lights rather than wax candles as an internal lighting source for ornaments. However, these prior arts fail to describe an ornament having an internal electric lighting that accurately imitates the lighting effect of a flickering candle.

As such, although the electric lights allow for cost saving and eliminate the safety hazards, the advantages of the candle light are lost. Specifically, the light provided by electric light is often harsh or fails to recreate the candle's flickering yet subdued lighting that provide a festive or relaxing environment.

Thus, it would be desirable to provide ornaments having an internal electric lighting that emulates the lighting effects of a candle flame.

### BRIEF DESCRIPTION OF THE DRAWINGS

The features and advantages of the present invention will become apparent from the following detailed description of the present invention in which:

FIG. 1 is a perspective view of a first embodiment of the present invention.

FIG. 2 is a cross sectional view of a first embodiment of the present invention.

FIG. 3 is a bottom view of a first embodiment of the present invention.

FIG. 4 is perspective view of a second embodiment of the present invention.

FIG. 5c is a cross sectional view of an embodiment of the present invention showing a connector fixed to the bottom of the housing and a removable light unit being placed into the housing via the top opening.

FIG. 5d is a cross sectional view of an embodiment of the present invention showing the removable light unit coupled to the connector.

FIG. 6a is a cross sectional view of a third embodiment of the present invention showing a plurality of battery-operated ornaments interconnected by an interconnect.

FIG. 6b is a cross sectional view of a fourth embodiment of the present invention showing a plurality of ornaments connected by an interconnect.

FIG. 6c is a cross sectional view of a fifth embodiment of the present invention showing a plurality of ornaments connected by an interconnect.

### DETAILED DESCRIPTION

Herein, certain details are set forth below in order to provide a thorough understanding of various embodiments of the invention, albeit the invention may be practiced through many embodiments other that those illustrated. Well-known components and operations may not be set forth in detail in order to avoid unnecessarily obscuring this description.

Moreover, in the following description, certain terminology is used to describe features of the invention. For example, a “controller” is broadly defined as hardware and/or software configured to control one or more functions conducted by another device. For instance, examples of a “controller” include, but are not limited or restricted to one or more integrated circuits (e.g., microprocessor, application specific integrated circuit, a digital signal processor, a micro-controller, etc.), a circuit board, a plug-in card, or even combinatorial logic.

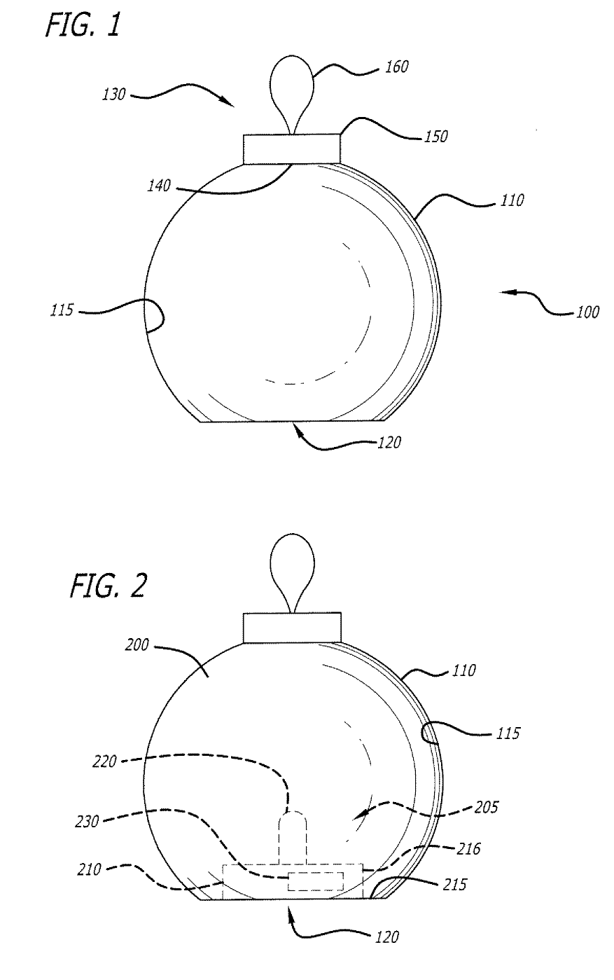

As illustrated in FIG. 1, an illustrative embodiment of an ornament 100 configured in accordance with a first embodiment of the invention is shown. Ornament 100 comprises a housing 110 to encapsulate a light unit including a light source and controller as described below. According to this embodiment of the invention, housing 100 may be arranged in a substantially spherical shape with a light mechanism (not shown) to control situated at or substantially near a bottom polar area 120 and a hanging mechanism 130 situated at or substantially near a top polar area 140. Housing 110 is formed of a translucent or transparent material such as wax, glass, plastics, fiberglass or any combination thereof. Of course, housing 110 may also be plain in color, transparent, textured, embossed, painted, decorated, or any combination thereof.

As further shown in this illustrative embodiment, hanging mechanism 130 is attached to or formed as a part of either bottom polar area 120 (not shown) or top polar area 140 of housing 110. More specifically, hanging mechanism 130 includes a cap portion 150 permanently or removably attached to top polar area 140. Examples of techniques for permanently attaching cap portion 150 to part of housing 110 include, but are not limited or restricted to formation of cap portion 150 as an integrated part of housing 110 or physical mating of cap portion 150 and housing 110 by use of an adhesive, thermal coupling or the like. Examples of techniques for removably attaching cap portion 150 to housing 110 include, but are not limited or restricted to a weaker adhesive or by interlocking the two pieces together. In order to allow ornament 100 to hang from a tree branch for example, a strand 160 is attached to cap portion 150 or top polar area 140. Strand 160 can be made of string, wire, plastic, metal or other material.

As shown in FIG. 2, housing 110 includes a hollow interior 200 that at least partially contains a light unit 205. For this embodiment of the invention, light unit 205 includes an electrical base 210 and a light source 220 formed as a single integrated unit. Base 210 is a casing, perhaps made of a non-conductive material such as plastic for example, that is configured to house a controller 230 and may feature manual controls (e.g., switches, buttons, etc.) used to control the operations of light unit 205. Of course, it is contemplated that base 210 and light source 220 may be separate components with the light source 220 being removable from base 210. For this embodiment, light source 220 is positioned on base 210 and is controlled by controller 230 placed within base 210.

According to one embodiment of the invention, base 210 is implemented as a bottom portion of housing 110 so as to be located within bottom polar area 120. As a result, a bottom wall 215 of base 210 is exposed while at least a portion of side wall 216 of base 210 rests within interior 200 of housing 110. Light unit 205 is inserted into housing 110 with bottom wall 215 of base 210 exposed while a portion of either bottom wall 215 or side wall 216 of base 210 is attached to interior wall 115 of housing 110. However, according to another embodiment of the invention, base 210 is attached to and mounted on an interior wall 115 of bottom wall 215 of housing 110. For instance, bottom wall 215 of base 210 may be attached to interior wall 115 of housing 110. For both of these embodiments, base 210 features a battery compartment to house one or more batteries that are used to supply power to controller 230 and light source 220.

Examples of light source 220 include, but are not limited or restricted to one or more light emitting diodes (LEDs), where the illumination of these LEDS, namely their lighting effect and color, is controlled at least in part by controller 230. More specifically, controller 230 selectively controls the operating modes of light source 220, which is adapted to operate in one of a plurality of operating modes as described below.

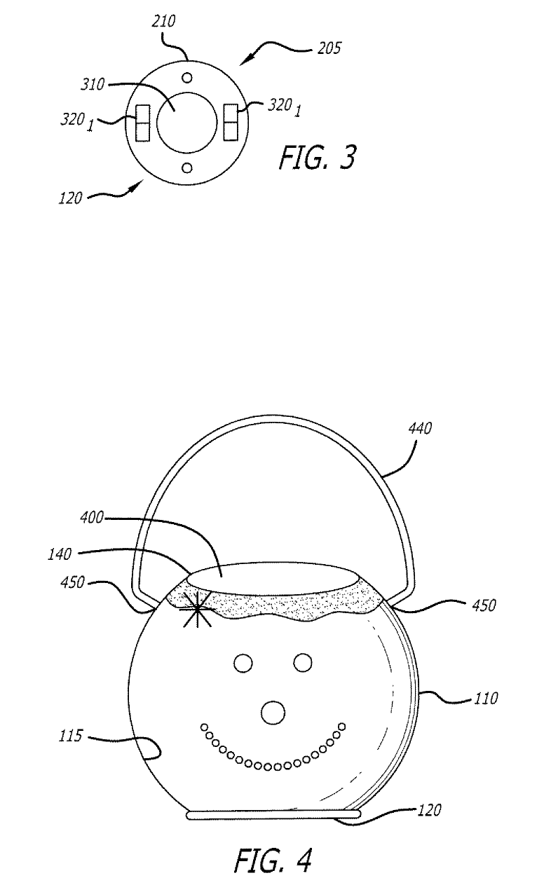

Referring now to FIG. 3, an illustrative embodiment of base 210 of light unit 205 that is at least partially exposed at bottom polar area 120 of housing 110 is shown. Base 210 features a battery compartment to house one or more batteries that are used to supply power to controller 230 and light source 220. The battery compartment may be concealed by a battery cover 310 that can be rotated or removable to allow for replacement of the battery. In another embodiment, light unit 205 may have a battery installed in base 210 that is not removable.

Base 210 further comprises one or more switches 320 that allow for selection of an operating mode of light unit 205 from among the plurality of operating modes. These operating modes represent at least one of a plurality of lighting effects (e.g., flickering light to emulate a candle, constant light, strobe light, color changing light, etc.) and at least one type of light (e.g., yellow or white light, a colored light, etc.). Herein, as shown, two or more switches 320₁-320_{N} (N≧2) are represented for illustrative purposes as devices for selecting of the operating modes for light unit 205. Of course, other manual control devices beside switches, such as a dial for example, may be used.

As shown in FIG. 3, as an exemplary embodiment, in a first operating mode, light source 220 of light unit 205 is powered ON and produces in a “flickering light” being a white or a colored light illumination that emulates a light pattern representative of lighting effects produced by a flickering candle flame. In the second operating mode, light source 220 is powered ON and controlled to provide a “constant light” being a white or a colored light with a generally constant illumination. In the third operating mode, light source 220 is powered ON and produces a “strobe light” being a white or colored light with a strobe illumination. In a fourth mode, the light source 220 is displaying a “color-changing light” being a light that alternates between multiple colors. In the fifth mode, light source 220 is powered OFF.

Referring now to FIG. 4, a second illustrative embodiment of the ornament is shown. Herein, housing 110 may be arranged in a substantially spherical shape with the light unit (not shown) situated near bottom polar area 120. Additionally, housing 110 includes an opening 400 situated at top polar area 140. Opening 400 allows access to light unit 205 positioned on interior wall 115 of housing 110. As further shown, in some embodiments, housing 10 includes a hanging device 440 permanently or removably attached to sides 450 of housing 110. Hanging device 440 allows this embodiment of the invention for example to be hung, carried, or used as a decorative component.

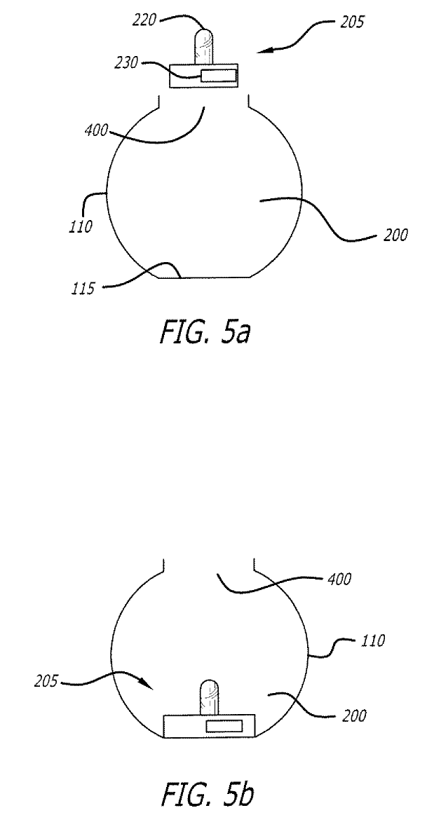

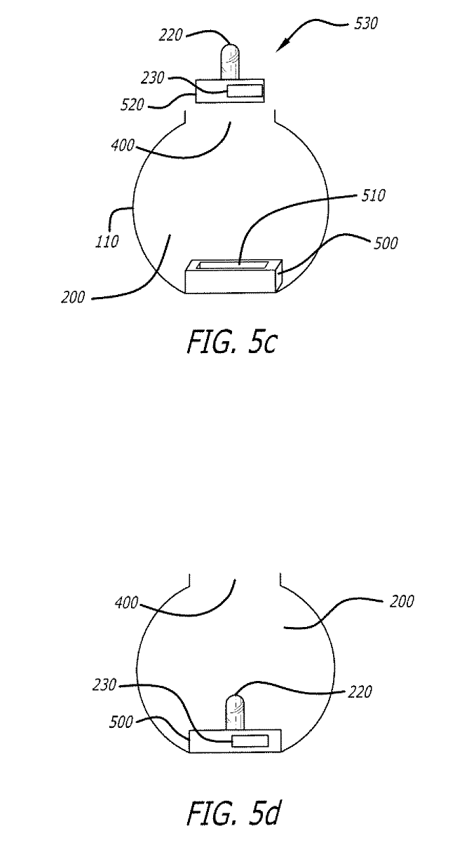

In FIGS. 5a and 5b, as shown, housing 110 includes a single opening 400 to allow light unit 205 to be placed into interior 200 of housing 110. Herein, light unit 205 is removable and can be placed within interior 200 of housing 110. Placed within interior 200 of housing, light unit 205 may be secured to bottom portion of interior 200 through an adhesive or fastening mechanism. However, it is contemplated that light unit 205 may not be secured and may simply reside within interior 200. By sizing light source to be substantially equivalent in size to a diameter of opening 400, movement of light unit 205 within interior can be minimized. Of course, alternatively, it is contemplated that light unit 205 maybe permanently attached to housing 110 as illustrated in FIGS. 1-3 shown above.

Alternatively, as shown in FIGS. 5c and 5d, an electrical base connector 500 may be formed into an interior region of housing 110. Herein, a top portion of electrical base connector 500 includes a connector cavity 510 that is sized to receive a removable component, such as a light unit 530 that is similar in design to light unit 205 of FIGS. 5a and 5b but with a different configuration for base 520. As a result, a bottom portion of electrical base connector 500 includes a battery compartment and manual controls similar to those controls located within base 210 of FIG. 3.

As further shown in FIGS. 5c and 5d, according to this embodiment of the invention, housing 110 includes opening 400 to allow light unit 530 to be placed into interior 200. Herein, base 520 features an electrical connector (not shown) that is adapted to mate with and to become electrically coupled to a physical connector (not shown) of electrical base connector 500, where the physical connector is located within connector cavity 510. This allows electrical connectivity between controller 230 placed within base 520 and a power source implemented within electrical base connector 500. Also, it allows base 520 to be removably coupled to electrical base connector 500. Alternatively, it is contemplated that light source 220 and controller 230 may be adapted to receive power from a power source (e.g., battery) located within base 520, and electrical base connector 500 simply provides manual controls for setting operating modes for light source 220 and controller 230.

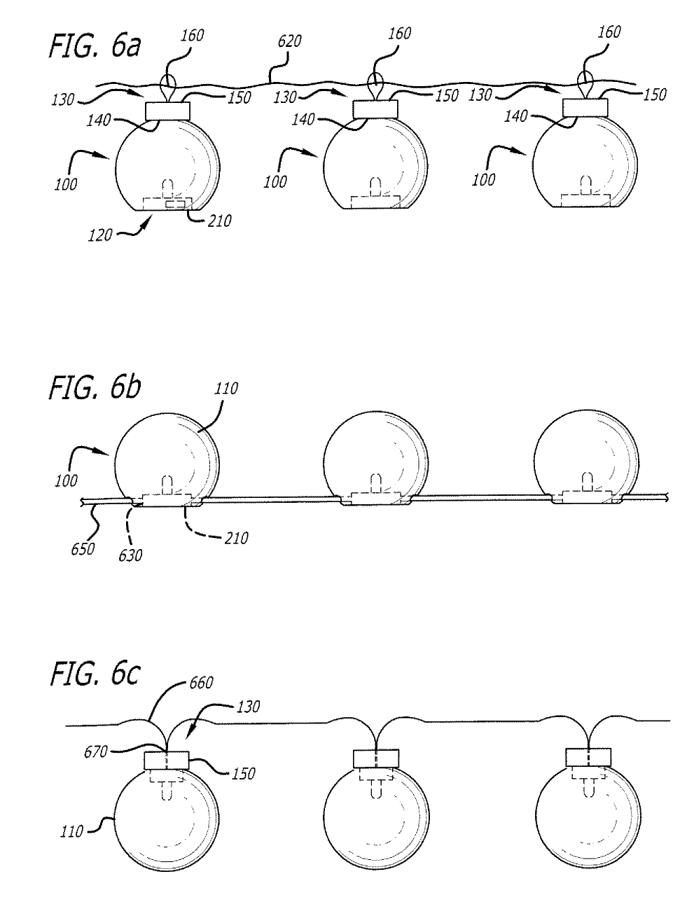

Referring to FIG. 6a, FIG. 6b, and FIG. 6c, illustrative embodiments of an ornament configured in accordance to the third, fourth and fifth embodiments are depicted.

As illustrated in FIG. 6a, according to the third embodiment, a plurality of ornaments 100 are connected via an interconnect 620. According to this embodiment, interconnect 620 can be made of string, plastic, metal or other materials. As shown, each of the plurality of ornaments 100 includes a hanging mechanism 130 positioned on top polar area 140 of housing 110. Hanging mechanism 130 can include cap portion 150 and strand 160. Interconnect 620 is passed through strand 160 of hanging mechanism 130 of each of the plurality of ornaments 100 such that the plurality of ornaments 100 are connected via interconnect 620. Referring to FIG. 6a, according to this embodiment, each of the plurality of ornaments 100 includes a light unit that is battery-operated such that base 210 located at bottom polar area 120 of housing 110 features a battery compartment to house a battery used to supply power to controller 230.

Referring now to FIG. 6b, an illustrative embodiment of an ornament configured in accordance to the fourth embodiment is shown. According to this embodiment, a plurality of ornaments are connected in series by interconnect 650 which is an electrical wire. As illustrated, interconnect 650 is routed to electrical bases 210 of the light units via openings 630 within housing 110 for each of these ornaments 100. Interconnect 650 supplies power to controllers located therein.

Referring to FIG. 6c, an illustrative embodiment of an ornament configured in accordance to the fifth embodiment is shown. As illustrated, this embodiment comprises a plurality of ornaments 100 connected by interconnect 660. According to this embodiment, interconnect 660 is an electrical wire which powers the light units that include a light source and a controller for controlling the light source, where the base of the light unit housing the controller is placed within cap portion 150 or is situated in the interior of housings 110 of each of the plurality of ornaments adjacent to cap portion 150. As further illustrated, interconnect 660 connects to each of controller 230 within the base via an opening 670 located in cap portion 150 of hanging mechanism 130.

Of course, in lieu of each light unit of FIGS. 6a-6c including a controller, it is contemplated that one or more controllers may be positioned along interconnect 660 and adapted to control the operating modes for a series of light units. For instance, interconnect 660 may feature a control line that is connected to each of the light units along the string of ornaments and at least one controller is adapted to select the operating mode for all of the light units. Alternatively, interconnect 660 may feature multiple control lines each connected to at least one of the light units along the string of ornaments. One or more controllers separate from light units are responsible for setting the operating mode for those light units connected by their corresponding control line. This allows a first group of light units on a string of ornaments to be set to a first operating mode while a second group of light units on the same string of ornaments can be set to a second, different operating mode. As a result, the first group of light units may provide a different lighting effect than the second group of light units.

While certain exemplary embodiments have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

What is claimed is:

1. An ornament, comprising:
a housing having a hollow interior including a first polar area; and
a light unit at least partially positioned within the interior of the housing, the light unit comprises;
a light source situated in the interior of the housing; and
a controller coupled to the light source, the controller to control the light source adapted to operate in one of a plurality of operating modes including a first mode where the light source emulates a light pattern representative of lighting effects produced by a candle flame.

2. The ornament of claim 1, wherein the housing includes a hanging mechanism situated on a second polar area opposite the first polar area.

3. The ornament of claim 1, wherein the light unit further comprises a base encasing the controller and including a plurality of manual control devices that are accessible and a predetermined setting of the manual control devices causes the controller to control the light source to operate in the first mode.

4. The ornament of claim 2, further comprising a connector is attached to the interior of the housing, the connector includes an opening to receive the light unit.

5. The ornament of claim 3, wherein the base houses a battery compartment to receive a replaceable battery.

6. The ornament of claim 1, wherein the first mode of the plurality of modes is a single-colored flickering light.

7. The ornament of claim 3, wherein the base includes one or more switches allowing for selection among the plurality of operating modes.

8. The ornament of claim 6, wherein the plurality of operating modes includes a second mode where the light source is displaying a color-changing constant light being a rotation of different colored lights.

9. The ornament of claim 6, wherein the plurality of operating modes include a second mode where the light source is displaying a color-changing flickering candle light, a color-changing constant light or a color-changing strobe light.

10. The ornament of claim 8, wherein the plurality of operating modes includes a third mode where the light source is powered ON/OFF.

11. The ornament of claim 2, wherein the hanging mechanism includes a cap coupled to the second polar area being a top polar area of the housing and a strand coupled to the cap.

12. The ornament of claim 1, wherein the housing includes an opening at a second polar area being a top polar area of the housing diametrically opposite the first polar area, the opening sized to receive a light unit including the light source and the controller.

13. An apparatus, comprising:
an interconnect;
a plurality of ornaments connected to the interconnect, each of the plurality of ornaments comprises:
a housing having a hollow interior and a base situated at a polar area of the housing, the base protruding into the hollow interior;
a light source situated in the interior of the housing; and
a controller coupled to the light source, the controller to control the light source adapted to operate in one of a plurality of operating modes including a first mode where the light source emulates a light pattern representative of lighting effects produced by a candle flame.

14. The apparatus in claim 13, wherein the housing includes an opening to receive the interconnect, the interconnect being an electrical wire powering the light source.

15. The apparatus in claim 13, wherein the housing includes a hanging mechanism having a cap with an opening at the top to receive the interconnect, the interconnect being an electrical wire powering the light source.

16. The apparatus in claim 13, wherein the light source is battery operated and the housing includes a hanging mechanism having a cap and a strand to receive the interconnect.

17. An ornament, comprising:
a housing having a hollow interior; and
a light unit situated at a polar area of the housing, the light unit comprises
a light source situated in the interior of the housing, and
a controller coupled to the light source, the controller to control the light source adapted to operate in one of a plurality of operating modes including a first mode where the light source emulates a color-changing light pattern representative of a rotation of a plurality of different colored lights.

18. The ornament of claim 17, wherein the plurality of the operating modes of the light source include the first mode where the light source emulates a color-changing light pattern and a second mode where the light source emulates a single-color flickering light pattern.

19. The ornament of claim 17, where the plurality of operating modes of the light source include the first mode where the light source emulates a color-changing light pattern and a second mode where the light source emulates a single-color light pattern set after halting the rotation of the plurality of different colored lights.

20. The ornament of claim 17 further comprising a switching mechanism coupled to the controller and situated on the base, the switching mechanism adapted to enable one of a plurality of operating modes.
